(19) United States
(12) Patent Application Publication
(10) Pub. No.: US 2013/0307833 A1
(43) Pub. Date: Nov. 21, 2013

(54) DISPLAY APPARATUS AND METHOD OF REPAIRING THE SAME

(71) Applicant: SAMSUNG DISPLAY CO., LTD., Gyeonggi-Do (KR)

(72) Inventors: June-Woo Lee, Gyeonggi-Do (KR); Jae-Beom Choi, Gyeonggi-Do (KR); Kwan-Wook Jung, Gyeonggi-Do (KR); Sung-Soo Choi, Gyeonggi-Do (KR); Seong-Jun Kim, Gyeonggi-Do (KR); Guang-Hai Jin, Gyeonggi-Do (KR); Ga-Young Kim, Gyeonggi-Do (KR); Jee-Hoon Kim, Gyeonggi-Do (KR)

(73) Assignee: Samsung Display Co., Ltd., Gyeonggi-Do (KR)

(21) Appl. No.: 13/665,579

(22) Filed: Oct. 31, 2012

(30) Foreign Application Priority Data
May 18, 2012 (KR) 10-2012-0053156

(51) Int. Cl. G06F 3/038

(52) U.S. Cl. 345/211

(57) ABSTRACT

A display apparatus is disclosed. The display apparatus includes a plurality of scan lines branching off from each of a plurality of scan wires. Each scan line connects one of the scan wires to adjacent sub pixels of the same color. An insulating layer is disposed between the scan lines and the scan wire. A plurality of contact holes is formed in the insulating layer so as to electrically connect the scan lines and the scan wires. In addition, a plurality of data lines intersect the scan lines, and are connected to the sub pixels, and first power supply lines extend in the second direction and connected to the plurality of sub pixels.

### CROSS-REFERENCE TO RELATED APPLICATIONS

This application claims the benefit of Korean Patent Application No. 10-2012-0053156, filed on May 18, 2012, in the Korean Intellectual Property Office, the disclosure of which is incorporated herein in its entirety by reference.

### BACKGROUND

1. Field

The disclosed technology relates to a display apparatus and a method of repairing the display apparatus.

2. Description of the Related Technology

An organic light-emitting display apparatus includes a thin film transistor (TFT), and an organic electroluminescent device (hereinafter referred to as an organic EL device) that is driven by the TFT and that emits light to form an image. That is, when current is supplied to the organic EL device through the TFT, light is emitted from the organic EL device to form an image.

Since various wires connected to the TFT are each formed to have a fine critical dimension (CD), some of the various wires may not be appropriately formed, for example, an open failure may occur during the manufacture of the organic light-emitting display apparatus.

### SUMMARY OF CERTAIN INVENTIVE ASPECTS

Another inventive aspect is a display apparatus including a plurality of unit pixels each including a plurality of sub pixels, where each sub pixel emits light of a predetermined color, a plurality of scan wires, a plurality of scan lines branching off from each of the scan wires and extending in a first direction, where each scan line connects one of the scan wires to adjacent sub pixels of the same color, and where the number of the scan lines for each scan wire is equal to the number of the plurality of sub pixels for each pixel, an insulating layer disposed between the scan lines and the scan wire, a plurality of contact holes formed in the insulating layer so as to electrically connect the scan lines and the scan wires, a plurality of data lines extending in a second direction intersecting the first direction, where the data lines are connected to the sub pixels, and first power supply lines extending in the second direction and connected to the plurality of sub pixels.

Another inventive aspect is a method of repairing a display apparatus which includes a plurality of unit pixels each including a plurality of sub pixels, where each sub pixel emits light of a predetermined color, a plurality of scan wires, and a plurality of scan lines branching off from each of the scan wires and extending in a first direction, where each scan line connects one of the scan wires to adjacent sub pixels of the same color, and where the number of the scan lines for each scan wire is equal to the number of the plurality of sub pixels for each pixel, a plurality of data lines extending in a second direction intersecting the first direction, where the data lines are connected to the sub pixels, and first power supply lines extending in the second direction and connected to the plurality of sub pixels, where the method includes detecting an open failure in one or more of the scan lines, repairing a scan line having an open failure, forming an insulating layer on the scan lines, forming a plurality of contact holes in the insulating layer, and forming the scan wire on the insulating layer to be electrically connected to the scan lines via the contact holes.

### BRIEF DESCRIPTION OF THE DRAWINGS

The above and other features and advantages and exemplary embodiments thereof are described with reference to the attached drawings in which:

FIG. 1 is a schematic plan view of an organic light-emitting display apparatus according to an embodiment;

FIG. 2 is a schematic diagram of a structure of wires in a region II of FIG. 1;

FIG. 3 is a schematic diagram of a structure of scan lines in regions III and III′ of FIG. 1;

FIG. 4 is an enlarged cross-sectional view of a region IV of FIG. 3;

FIGS. 5A to 5C are diagrams illustrating a process of forming the scan lines of FIG. 3, according to an embodiment;

FIG. 6 is a schematic diagram of a structure of scan lines according to a comparative example;

FIG. 7 is a schematic diagram of a structure of scan lines according to another embodiment;

FIG. 8 is a circuit diagram of a wire structure of a sub pixel of an organic light-emitting display apparatus, according to an embodiment; and

FIG. 9 is a schematic cross-sectional view of some elements of each sub pixel of the organic light-emitting display apparatus of FIG. 1, according to an embodiment.

### DETAILED DESCRIPTION OF CERTAIN INVENTIVE EMBODIMENTS

Hereinafter, exemplary embodiments are described more fully with reference to the accompanying drawings. As used herein, expressions such as “at least one of,” when preceding a list of elements, modify the entire list of elements and do not modify the individual elements of the list.

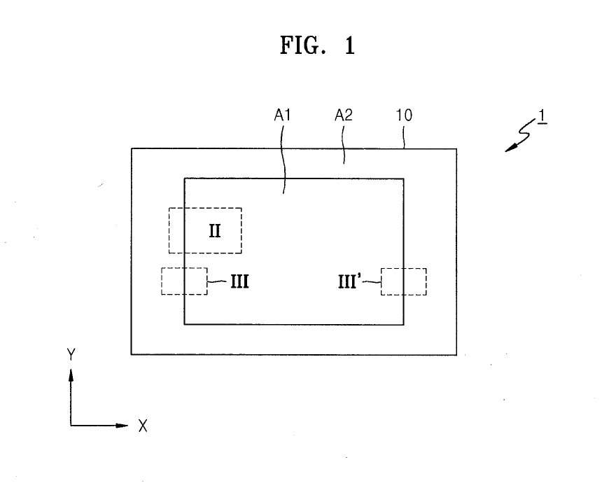

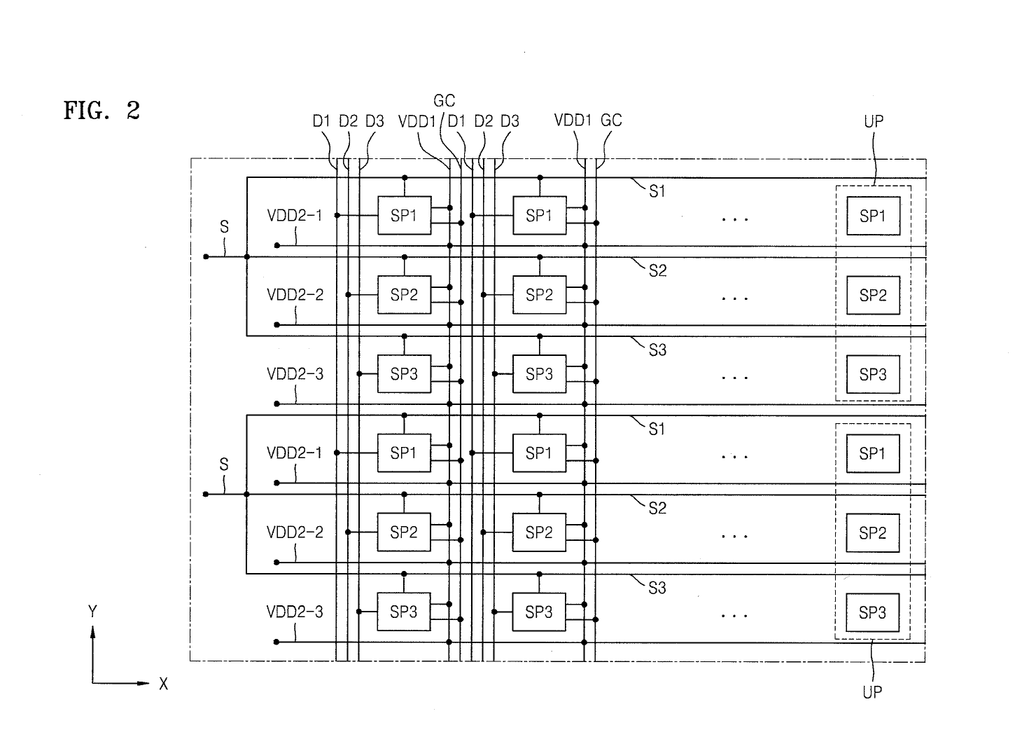

FIG. 1 is a schematic plan view of an organic light-emitting display apparatus 1 according to an embodiment. FIG. 2 is a schematic diagram of a structure of wires in a region II of FIG. 1.

Referring to FIG. 1, in the organic light-emitting display apparatus 1 of the current embodiment, a display area A1 and a non-display area A2 are defined on a substrate 10. Referring to FIG. 2, the display area A1 includes a plurality of unit pixels UP in which an image is formed.

Each of the unit pixels UP includes a plurality of sub pixels SP1, SP2, and SP3 that emit different colors in a second direction (Y-axis direction). For example, each of the unit pixels UP may include a sub pixel that emits red, a sub pixel that emits green, and a sub pixel that emits blue. Although in the current embodiment, the three sub pixels SP1, SP2, and SP3 form each of the unit pixels UP, the present invention is not limited thereto. That is, as long as light emitted from a plurality of sub pixels is mixed to emit white or specific color, the number of sub pixels of each of the unit pixels UP may increase or decrease.

In the display area A1, the sub pixels SP1 that emit the same color are disposed in a first direction (X-axis direction). The sub pixels SP1, SP2, and SP3 that emit different colors are alternately disposed in the second direction (Y-axis direction) perpendicular to the first direction (X-axis direction). The sub pixels SP1, SP2, and SP3 that emit different colors form one unit pixel UP.

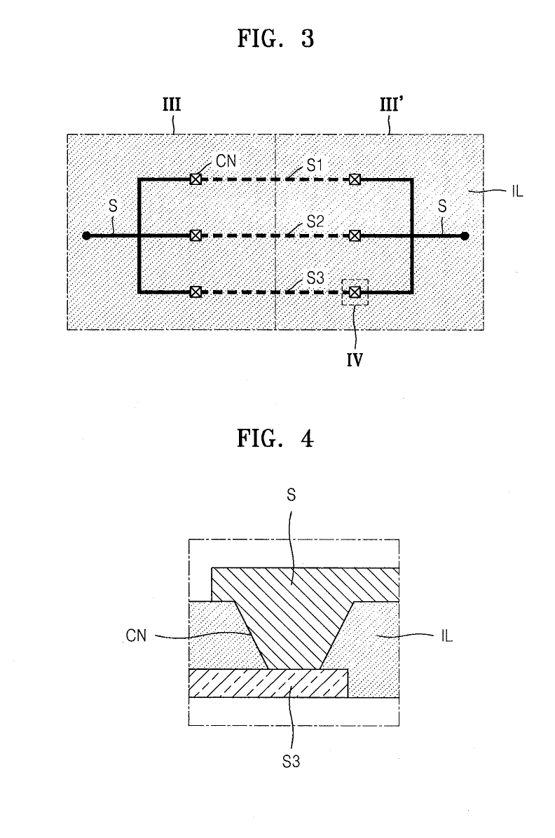

In each of the unit pixels UP, the first through third scan lines S1, S2, and S3 that branch off from one scan wire S are arranged to extend in the first direction (X-axis direction). The first through third scan lines S1, S2, and S3 that branch off from one scan wire S, and the scan wire S are disposed on different layers while having an insulating layer IL (see FIGS. 3 and 4) disposed therebetween.

Each of the first scan lines Si is connected to the sub pixel SP 1 that emits a first color of a neighboring unit pixel UP thereof. Each of the second scan lines S2 is connected to the sub pixel SP2 emits a second color of a neighboring unit pixel UP thereof. Each of the third scan lines S3 is connected to the sub pixel SP3 emits a third color of a neighboring unit pixel UP thereof. Although the sub pixels SP1, SP2, and SP3 of one unit pixel UP are respectively connected to the first through third scan lines S1, S2, and S3, the first through third scan lines S1, S2, and S3 branch off from the same scan wire S and the same scan signal is thus input to the sub pixels SP1, SP2, and SP3.

In each of the unit pixels UP, first through third data lines D1, D2, and D3 are disposed to be independently and respectively connected to the sub pixels SP1, SP2, and SP3 that extend in the second direction (Y-axis direction) and that emit different colors. That is, the first data line D1 is connected to the sub pixel SP1 that emits the first color, the second data line D2 is connected to the sub pixel SP2 that emits the second color, and the third data line D3 is connected to the sub pixel SP3 that emits the third color. Thus, different data signals may be input to the sub pixels SP1, SP2, and SP3 of each of the unit pixels UP.

In the current embodiment, lengths of the first through third data lines D1, D2, and D3 are shorter that those of the first through third scan lines S1, S2, and S3. If the lengths of the first through third data lines D1, D2, and D3 were greater, the intensities of data signals input to the sub pixels SP1, SP2, and SP3 would be lowered due to wire resistances and capacitances according to the lengths. In general, an organic light-emitting display apparatus is more sensitive to a data signal than to a scan signal. Thus, in the current embodiment, non-uniformity of data signals input to the organic light-emitting display apparatus 1 may be reduced or prevented.

In the display region A1, first power supply lines VDD1 extend in the second direction (Y-axis direction) and are connected to the sub pixels SP1, SP2, and SP3 so as to supply power to the sub pixels SP1, SP2, and SP3. In the current embodiment, since the first power supply lines VDD1 are disposed in the second direction (Y-axis direction), the lengths of the first power supply lines VDD1 are shorter than those of the first through third scan lines S1, S2, and S3. This is because a voltage drop may occur in the first power supply lines VDD1 due to resistance, caused when the first power supply lines VDD1 are long.

To prevent a voltage drop from occurring in the first power supply lines VDD1, additional power supply lines may be further connected to the sub pixels SP1, SP2, and SP3. In the current embodiment, the sub pixels SP1, SP2, and SP3 included in one unit pixel UP are connected to the first power supply line VDD1, and are further connected to second power supply lines VDD2-1, VDD2-2, and VDD2-3 extending in the first direction (X-axis direction). The second power supply lines VDD2-1, VDD2-2, and VDD2-3 may be continuously disposed between the first through third scan lines S1, S2, and S3 respectively connected to the sub pixels SP1, SP2, and SP3 of one unit pixel UP. In the current embodiment, each of the second power supply lines VDD2-1, each of the second power supply lines VDD2-2, and each of the second power supply lines VDD2-3 are respectively connected to the sub pixels SP1, the sub pixels SP2, and the sub pixels SP3 included in the plurality of unit pixels UP, but the present invention is not limited thereto.

The organic light-emitting display apparatus 1 of the current embodiment may further include a compensation control signal line GC to compensate for a threshold voltage of a third TFT TR3 (see FIG. 8). The compensation control signal line GC may extend in the second direction (Y-axis direction) to be connected to the sub pixels SP1, SP2, and SP3.

In general, the first power supply line VDD1 is formed to be wider than the first through third scan lines S1, S2, and S3 or the first through third data lines D1, D2, and D3. However, since the first through third scan lines S1, S2, and S3 (or the first through third data lines D1, D2, and D3) each have a fine critical dimension (CD), some wires may thus not be appropriately formed, for example, an open failure may occur during the manufacture of the organic light-emitting display apparatus 1.

As described above, since the first through third data lines D1, D2, and D3 are independently and respectively connected to the sub pixels SP1, SP2, and SP3 included in each of the unit pixels UP, it is possible to independently determine whether the open failure occurs in the first through third data lines D1, D2, and D3. However, since the first through third scan lines S1, S2, and S3 that are respectively connected to the sub pixels SP1, SP2, and SP3 included in each of the unit pixels UP branch off from one scan wire S, it is not easy to determine whether the open failure occurs in the first, second, or third scan line S1, S2, or S3.

FIG. 3 is a schematic diagram of a structure of scan lines in regions III and III′ of FIG. 1. FIG. 4 is an enlarged cross-sectional view of a region IV of FIG. 3. Referring to FIG. 3, the scan wire S from which the first through third scan lines S1, S2, and S3 are to branch off is disposed at a boundary of the display area A1.

Referring to FIGS. 3 and 4, in the current embodiment, the first to third scan lines S1, S2, and S3 connected to the sub pixels SP1, SP2, and SP3 of FIG. 2, and the scan wire S are formed at different layers while having the insulating layer IL therebetween. Each of the first to third scan lines S1, S2, and S3 connected to the sub pixels SP1, SP2, and SP3 of FIG. 2, and the scan wire S are electrically connected via one of contact holes CN formed in the insulating layer IL.

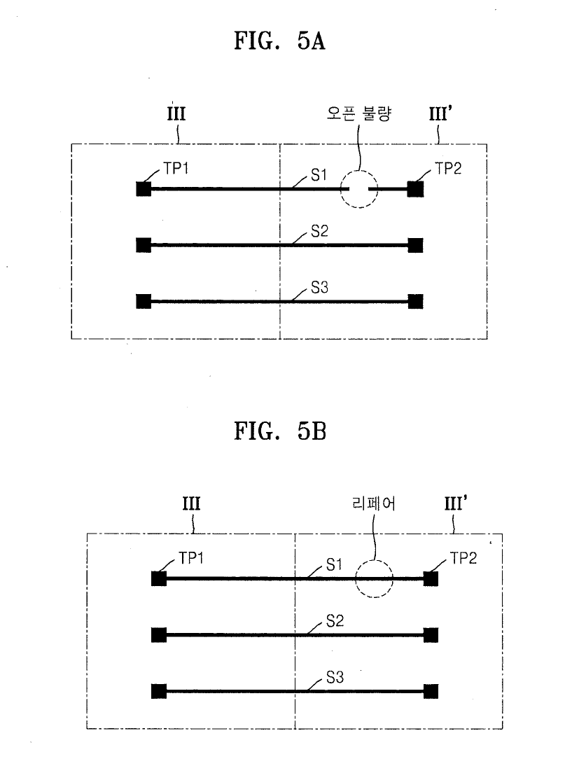

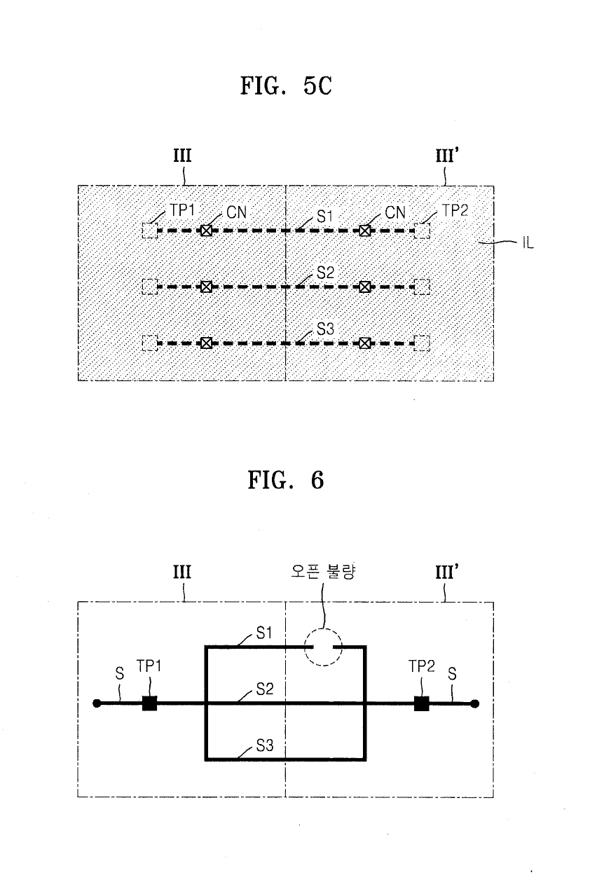

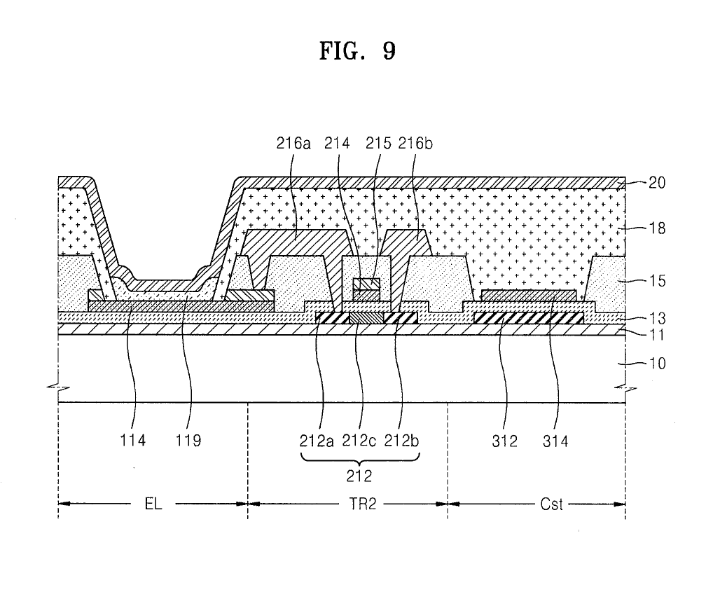

FIGS. 5A to 5C are diagrams illustrating a process of forming the first to third scan lines S1, S2, and S3 of FIG. 3, according to an embodiment. Referring to FIG. 5A, first, the first to third scan lines S1, S2, and S3 are formed to extend in the first direction (X-axis direction) so as to be respectively connected to the sub pixels SP1, SP2, and SP3 of FIG. 2. In this case, the first to third scan lines S1, S2, and S3 may be formed on a layer on which a first gate electrode layer 214 and a second gate electrode layer 215 of a thin film transistor (TFT) (see FIG. 9) are disposed.

If the open failure occurs in the first scan line S1 as illustrated in FIG. 5A, a user may detect the open failure of the first scan line Si by measuring the difference between voltages of both ends of each of the first to third first to third scan lines S1, S2, and S3 by using a first test pad TP1 and a second test pad TP2, which are respectively connected to both ends of each of the first to third first to third scan lines S1, S2, and S3, as a power feeding member and a power receiving member.

Then, referring to FIG. 5B, the open failure of the first scan line S1 is repaired. The open failure may be repaired according to any of various methods, e.g., chemical vapor deposition (CVD).

Then, referring to FIG. 5C, after the open failure of the first scan line S1 is repaired, the insulating layer IL is formed on the first to third scan lines S1, S2, and S3 that branch off from the scan wire S (see FIG. 2). Then, in the insulating layer IL, contact holes CN are formed to expose both sides of the first to third scan lines S1, S2, and S3.

Referring back to FIGS. 3 and 4, one scan wire S from which the first through third scan lines S1, S2, and S3 are to branch off is formed on the insulating layer (IL), and are then electrically connected to the first to third scan lines S1, S2, and S3 that branch off from the scan wire S, via the contact holes CN of FIG. 5C. The scan wire S may be formed on a layer on which the first to third data lines D1, D2, and D3 of FIG. 2 and/or the first power supply line VDD1 is disposed.

FIG. 6 is a schematic diagram of a structure of first to third scan lines S1, S2, and S3 according to a comparative example. Referring to FIG. 6, a scan wire S, and the first to third scan lines S1, S2, and S3 are formed on the same layer to be connected to one another without using the insulating layer IL of FIGS. 3 and 4.

When the open failure occurs in the first scan line S1 as illustrate in FIG. 6, it is difficult for a user to determine whether the open failure occurs in the first, second or third scan lines S1, S2, or S3 by measuring the difference between voltages of both ends of each of the first to third scan lines S1, S2, and S3 by using a first test pad TP1 and a second test pad TP2 installed on the scan wire S as a power feeding member and a power receiving member, since the first scan line S1 is connected to the second scan line S2 and the third scan line S3 via the scan wire S.

In contrast, according to the above embodiment, the scan wire S is not formed on a layer on which the first to third scan lines S1, S2, and S3 that branch off from the scan wire S are disposed. Instead, the scan wire S is formed on the insulating layer IL to be electrically connected to the first to third scan lines S1, S2, and S3 via the contact holes CN, after whether the open failure occurs in the first, second, or third scan line S1, S2, or S3 is determined and the open failure is repaired. Thus, it is possible to exactly determine whether the open failure occurs in the first, second, or third scan line S1, S2, or S3, and to reduce costs and a time needed to repair the open failure.

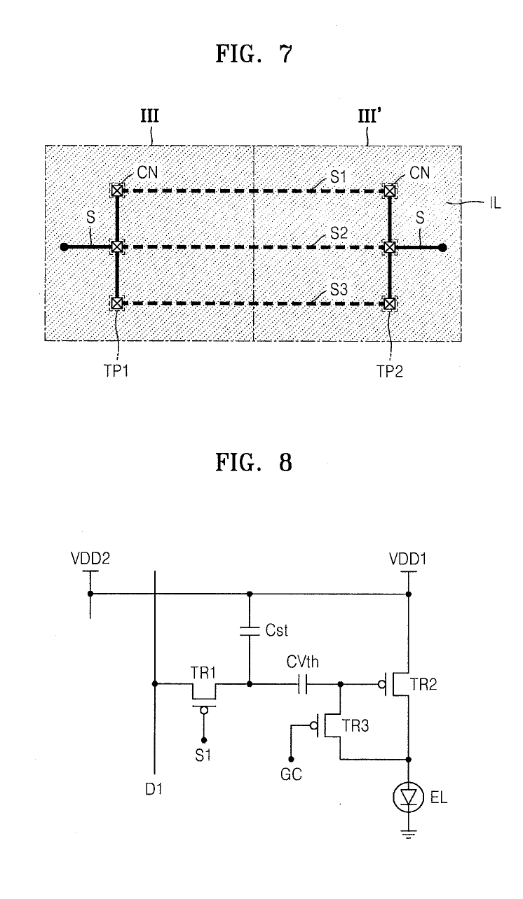

FIG. 7 is a schematic diagram of a structure of first to third scan lines S1, S2, and S3 according to another embodiment. Referring to FIG. 7, one scan wire S from which the first through third scan lines S1, S2, and S3 are to branch off is disposed at a boundary of the display area A1 of FIG. 1.

Similar to the structure of the first to third scan lines S1, S2, and S3 of FIG. 3, the first through third scan lines S1, S2, and S3 connected to the sub pixels SP1, SP2, and SP3 of FIG. 2, and the scan wire S are formed on different layers while having an insulating layer IL therebetween, and are electrically connected to one another via contact holes CN formed in the insulating layer IL. However, the current embodiment is different from the embodiment of FIG. 3 at least in that each of the contact holes CN is formed at a position corresponding to one of first and second test pads TP1 and TP2 installed at both ends of each of the first through third scan lines S1, S2, and S3.

FIG. 8 is a circuit diagram of a wire configuration of a sub pixel of the organic light-emitting display apparatus 1, according to an embodiment of the present invention.

Referring to FIG. 8, the sub pixel includes a first TFT TR1 that is a switching TFT, a second TFT TR2 that is a driving TFT, the third TFT TR3 that is a compensation signal TFT, capacitors Cst and Cvth that are storage elements, and an organic electroluminescent device (hereinafter referred to as the organic EL device) driven by the first through third TFTs TR1, TR2, and TR3. The number of TFTs and the number of capacitors are not limited to those shown in FIG. 3. That is, the present invention may be applied to an organic light-emitting display apparatus including at least two TFTs and at least one capacitor.

FIG. 8 illustrates the sub pixel SP1 that emits a first color among the sub pixels SP1, SP2, and SP3 of FIG. 2. That is, the first TFT TR1 is switched on by a scan signal supplied via first scan line S1, and delivers a data signal supplied via a first data line D1 to the capacitors Cst and Cvth and the second TFT TR2. The second TFT TR2 determines an amount of current to be supplied to the organic EL device via a first power supply line VDD1 and a second power supply line VDD2, according to the data signal delivered from the first TFT TR1, and then supplies the current to the organic EL device. The third TFT TR3 is connected to a compensation control signal line GC so as to compensate for a threshold voltage.

In the current embodiment, the second power supply line VDD2 is electrically connected to the first power supply line VDD1. Thus, even if the first power supply line VDD1 is short-circuited, the second power supply line VDD2 may function as a bypass line to drive the organic EL device.

FIG. 9 is a schematic cross-sectional view of some elements of each sub pixel of the organic light-emitting display apparatus 1 of FIG. 1, according to an embodiment.

Referring to FIGS. 1 and 9, a second TFT TR2 that is a driving TFT, a storage capacitor Cst, and an organic EL device EL are disposed on the substrate 10. As described above, the sub pixel further includes a first TFT TR1, a third TFT TR3, a compensation capacitor Cvth, and various wires, but only some elements of the sub pixel are briefly described with reference to FIG. 9 below.

The substrate 10 may be formed of a SiO₂-based transparent glass material, but is not limited thereto and may be formed of a transparent plastic material. A buffer layer 11 may be further formed on the substrate 10. The buffer layer 11 provides a planar surface on the substrate 10 and prevents moisture and foreign substances from penetrating into the substrate 10.

An active layer 212 of the second TFT TR2 is formed on the buffer layer 11. The active layer 212 may be formed of an inorganic semiconductor, such as amorphous silicon or polysilicon. The active layer 212 may be formed of any of various materials, e.g., organic semiconductor or an oxide semiconductor. The active layer 212 includes a source region 212b, a drain region 212a, and a channel region 212c.

A gate electrode first layer 214 and a gate electrode second layer 215 formed of a transparent conductive material are sequentially disposed on a location of the active layer 212 corresponding to the channel region 212c of the active layer 212, between patterns of a first insulating layer 13 that is a gate insulating film. As described above, the gate electrode first layer 214 and the gate electrode second layer 215 may be formed on a layer on which the first to third scan lines S1, S2, and S3 (see FIG. 3) connected to the sub pixels SP1, SP2, and SP3 (see FIG. 2) are disposed.

A source electrode 216b and a drain electrode 216a are disposed on the gate electrode second layer 215 between patterns of and a second insulating layer 15 that is an interlayer insulating film to be respectively connected to the source region 212b and the drain region 212a of the active layer 212. The source electrode 216b and the drain electrode 216a may be formed either on a layer on which the first to third data lines D1, D2, and D3 (see FIG. 3) are disposed or on a layer on which the scan wire S of FIG. 3 is disposed. The insulating layer 15 may be formed of a material used to form the insulating layer IL of FIG. 4 disposed between the first to third scan lines S1, S2, and S3 that branch off from the scan line S, and the scan line S.

A third insulating layer 18 is disposed on the second insulating layer 15 to cover the source electrode 216b and the drain electrode 216a. The third insulating layer 18 may be formed of an organic insulating film.

A first pixel electrode layer 114 is formed on the buffer layer 11 and the first insulating layer 13 by using a transparent conductive material used to form the gate electrode first layer 214. The transparent conductive material may include at least one material selected from the group consisting of an indium tin oxide (ITO), an indium zinc oxide (IZO), a zinc oxide (ZnO), an indium oxide (In₂O₃), an indium gallium oxide (IGO), and an aluminum zinc oxide (AZO).

An emission layer 119 is formed on the first pixel electrode layer 114. Light emitted from the emission layer 119 is discharged toward the substrate 10 through the first pixel electrode layer 114 formed of the transparent conductive material.

The emission layer 119 may be formed of a low-molecular weight organic material or a high-molecular weight organic material. If the emission layer 119 is formed of the low-molecular weight organic material, a hole transport layer (HTL), a hole injection layer (HIL), an electron transport layer (ETL), and an electron injection layer (EIL) may be stacked with respect to the emission layer 119. Other various layers may further be stacked if needed. In this regard, available organic materials may include copper phthalocyanine (CuPc), N,N′-Di(naphthalene-1-yl)-N,N′-diphenyl-benzidine (NPB), tris-8-hydroxyquinoline aluminum (Alq3), etc.

If the emission layer 119 is formed of the high-molecular weight organic material, the emission layer 119 may include an HTL. The HTL may be poly-(3,4)-ethylene-dihydroxy thiophene (PEDOT) or polyaniline (PANI). In this regard, available organic materials may include a polyphenylene vinylene (PPV)-based polymer organic material and a polyfluorene-based polymer organic material.

An opposition electrode 20 is stacked as a common electrode on the emission layer 119. In the organic light-emitting display apparatus of the current embodiment, the first pixel electrode layer 114 functions as an anode and the opposition electrode 20 functions as a cathode, or vice versa.

The opposition electrode 20 may be a reflective electrode including a reflective material. In this regard, the opposition electrode 20 may include at least one material selected from the group consisting of Al, Mg, Li, Ca, LiF/Ca, and LiF/Al.

Since the opposition electrode 20 serves as the reflective electrode, light emitted from the emission layer 119 is reflected from the opposition electrode 20, transmits through the first pixel electrode layer 114 formed of the transparent conductive material, and is then discharge toward the substrate 10.

Since the organic light-emitting display apparatus of the present embodiment is a bottom emission type display apparatus in which light is emitted toward the substrate 10, the first pixel electrode layer 114 may be formed not to overlap with the first through third scan lines S1, S2, and S3, the first through third data lines D1, D2, and D3, the first power supply line VDD1, and the second power supply lines VDD2-1, VDD2-2, and VDD2-3 (see FIG. 2).

On the substrate 10 and the buffer layer 11, a lower electrode 312 and an upper electrode 314 of the capacitor Cst are disposed, and a first insulating layer 13 is disposed between the upper electrode 312 and the upper electrode 314. The lower electrode 312 is formed of a material used to form the active layer 212 of the second TFT TR2. The upper electrode 314 includes a transparent conductive material that is the same material as the first pixel electrode layer 114.

The first insulating layer 13 is disposed on the lower electrode 312 but is not disposed at a boundary of the upper electrode 314. The second insulating layer 15 is disposed on the first insulating layer 13 to expose the entire upper electrode 314 so that the upper electrode 314 entirely contacts the third insulating layer 18.

Although not shown, a sealing member (not shown) may be disposed on the opposition electrode 20 to face one surface of the substrate 10. The sealing member protects the emission layer 119 from external moisture or oxygen. The sealing member may be formed of glass or plastic, or may have a structure in which organic materials and inorganic materials overlap with each other.

A display apparatus and a method of repairing the same according to an embodiment of the present invention have advantages described below.

First, a scan wire is not formed on a layer on which scan lines that branch off from the scan wire are disposed, but is instead formed on an additional insulating layer and is electrically connected to the scan lines via contact holes in the insulating layer, after an open failure of any of the scan lines is detected and repaired. Thus, it is possible to exactly detect a scan line having the open failure, and reduce costs and a time needed to repair the open failure.

Second, according to an embodiment, sub pixels of each unit pixel each include scan lines that branch off from one scan wire, data lines that are independently connected to the sub pixels, first power supply lines disposed perpendicularly to the scan lines, and second power supply lines being vertically connected to the first power supply lines. Accordingly, it is possible to reduce or prevent a voltage drop from occurring in the first power supply lines.

While the present invention has been particularly shown and described with reference to exemplary embodiments thereof, it will be understood by those of ordinary skill in the art that various changes in form and details may be made therein.

What is claimed is:

1. A display apparatus comprising:
a plurality of unit pixels each including a plurality of sub pixels, wherein each sub pixel emits light of a predetermined color;
a plurality of scan wires;
a plurality of scan lines branching off from each of the scan wires and extending in a first direction, wherein each scan line connects one of the scan wires to adjacent sub pixels of the same color, and wherein the number of the scan lines for each scan wire is equal to the number of the plurality of sub pixels for each pixel;
an insulating layer disposed between the scan lines and the scan wire;
a plurality of contact holes formed in the insulating layer so as to electrically connect the scan lines and the scan wires;
a plurality of data lines extending in a second direction intersecting the first direction, wherein the data lines are connected to the sub pixels; and
first power supply lines extending in the second direction and connected to the plurality of sub pixels.

2. The display apparatus of claim 1, wherein the plurality of sub pixels included in each of the plurality of unit pixels are sequentially arranged in the second direction.

3. The display apparatus of claim 2, wherein the data lines are each connected to sub pixels of the same color.

4. The display apparatus of claim 1, wherein the scan wire is disposed on a layer on which the data lines are disposed.

5. The display apparatus of claim 1, wherein the scan wire is disposed on a layer on which the first power supply lines are disposed.

6. The display apparatus of claim 1, wherein the data lines are shorter than the scan lines.

7. The display apparatus of claim 1, wherein the first power supply lines are shorter than the scan lines.

8. The display apparatus of claim 1, further comprising second power supply lines extending in the first direction and connected to the first power supply lines.

9. The display apparatus of claim 1, further comprising a plurality of test pads at both ends of each of the scan lines.

10. The display apparatus of claim 9, wherein the contact holes are respectively formed in locations corresponding to the test pads.

11. The display apparatus of claim 1, wherein each of the plurality of sub pixels comprises a first electrode, a second electrode, and an organic emission layer disposed between the first and second electrodes.

12. The display apparatus of claim 11, wherein the first electrode is a transparent electrode, and the second electrode is a reflective electrode.

13. The display apparatus of claim 11, wherein the scan lines, the data lines, and the first power supply voltage line do not overlap with the first electrodes.

14. The display apparatus of claim 1, further comprising second power supply lines extending in the first direction and connected to the first power supply lines.

15. The display apparatus of claim 1, further comprising compensation control signal lines extending in the second direction to be connected to the plurality of sub pixels.

16. The display apparatus of claim 1, wherein each of the plurality of sub pixels comprises at least two thin film transistors (TFTs) and at least one capacitor.

17. The display apparatus of claim 16, wherein:
each of the at least two TFTs comprises an active layer, a gate electrode, a source electrode, and a drain electrode, and
the insulating layer is disposed between the gate electrode and the source electrode, and between the gate electrode and the drain electrode.

18. The display apparatus of claim 17, wherein:
the scan lines are disposed on a layer on which the gate electrode is disposed, and
the scan wire is disposed on a layer on which the source electrode and the drain electrode are disposed.

19. A method of repairing a display apparatus which includes:
a plurality of unit pixels each including a plurality of sub pixels, wherein each sub pixel emits light of a predetermined color, a plurality of scan wires, and a plurality of scan lines branching off from each of the scan wires and extending in a first direction, wherein each scan line connects one of the scan wires to adjacent sub pixels of the same color, and wherein the number of the scan lines for each scan wire is equal to the number of the plurality of sub pixels for each pixel,
a plurality of data lines extending in a second direction intersecting the first direction, wherein the data lines are connected to the sub pixels, and
first power supply lines extending in the second direction and connected to the plurality of sub pixels, wherein
the method comprises:
detecting an open failure in one or more of the scan lines;
repairing a scan line having an open failure;
forming an insulating layer on the scan lines;
forming a plurality of contact holes in the insulating layer; and
forming the scan wire on the insulating layer to be electrically connected to the scan lines via the contact holes.

20. The method of claim 19, wherein the open failure is detected by determining the difference between voltages of both ends of each of the scan lines.

21. The method of claim 19, wherein:
each of the scan lines comprises test pads disposed at both ends thereof, and
the open failure is detected by determining the difference between voltages applied to the test pads.

22. The method of claim 21, wherein the contact holes are formed in locations corresponding to the test pads.

23. The method of claim 19, wherein the scan wires are formed on a layer on which the data lines are disposed.

24. The method of claim 19, wherein the scan wires are formed on a layer on which the first power supply lines are disposed.
